(19) United States
(12) Patent Application Publication
(10) Pub. No.: US 2014/0275383 A1
(43) Pub. Date: Sep. 18, 2014

(54) Polybutadiene-Based Coatings for Containers

(71) Applicant: Delta Case, LLC, Melrose Park, IL (US)

(72) Inventors: John Bittle, Downers Grove, IL (US); Victor Deeb, Marlborough, MA (US)

(21) Appl. No.: 14/212,629

(22) Filed: Mar. 14, 2014

Related U.S. Application Data
(60) Provisional application No. 61/791,599, filed on Mar. 15, 2013.

(51) Int. Cl. C09D 147/00

(52) U.S. Cl. CPC C09D 147/00
USPC 524/376; 524/508

(57) ABSTRACT

Compositions for coating food, beverage, and consumer product containers. Compositions and methods for coating the surfaces of beverage, food, consumer good and packaging-related materials containers are disclosed. The disclosed compositions employ butadiene polymers as a component of non-volatile component, thus avoiding the use of bisphenol A and related compounds, which are asserted by some researchers to be potentially harmful to human health. The coating compositions may be used on a wide variety of containers, ranging from small plastic containers, beverage cans, canned food containers, and multi-gallon drums and canisters.

### CROSS-REFERENCE TO RELATED APPLICATIONS

This application claims the benefit under 35 U.S.C. §119(e) of the earlier filing date of U.S. Provisional Patent Application No. 61/791,599 filed on Mar. 15, 2013.

### BACKGROUND OF THE INVENTION

1. Field of the Invention

The present invention relates generally to the field of coatings for containers, and more specifically to providing polymeric butadiene coatings for containers.

2. Description of the Background

Containers for housing foodstuffs, beverages, consumer goods and packaging-related materials are commonly fabricated from metal or plastics. To improve storage stability of the foodstuffs, beverages, consumer goods, and packaging-related materials, those containers are often coated with a layer of (or fabricated from) protective polymer.

Historically, a large percentage of materials used in the interior protection and exterior decoration of food, beverage, consumer goods and industrial packaging articles are epoxy-based coatings produced from resinous components synthesized with bisphenol A, bisphenol F, and/or aromatic glycidal ether as basic building-blocks. These epoxy-based coatings have successfully been used for decades in providing packaging articles that withstand the rigors of long-term storage conditions with a large variety of different food-types, beverages, myriad consumer goods, and packaging-related materials while preventing spoilage of the contents. Spoilage of the contents may occur if the contents cause a degradation of the protective coatings over a period of time causing bare metal exposure, corrosion, bacterial incubation, or flavor/carbonation loss. Epoxy-based coatings have been time tested and proven to prevent these from occurring in numerous settings and implementations.

Recently, numerous publications have raised concerns regarding the safety of bisphenol A (and related compounds)-containing coatings. Some researchers have asserted that bisphenol A has or can have steroidal effects in the human body. Research efforts have focused on identifying an alternative to bisphenol A-containing epoxy coating products. Preferably, that alternative would be substantially free of bisphenol A, bisphenol F, and aromatic glycidal ethers and would alleviate much of the public's concerns regarding the unwanted physiological effects of bisphenol A.

It has been recently found that the alternative coating materials developed to date are not as universally useful as the epoxy-based coating products. To make up for the shortcomings associated with the alternative coating materials, it is often necessary to use more expensive and less efficient means of manufacturing packaging articles and in packaging foods, beverages, consumer goods and packaging-related materials. Examples of limitations of these alternative materials include 1) they are generally more expensive to produce; 2) much larger amounts or multiple layers of the materials are applied to allow the surface to withstand a wide variety of chemically aggressive packaged products; 3) the materials sometimes require more expensive treatments to metal substrates prior to administration, such as depositing increased levels of tin on the surface of the substrate, to gain increased corrosion resistance; and 4) their use results in food, beverage, and consumer goods having a reduced “shelf life.”

During the typical life cycle of a packaged food, beverage, or consumer good product, it is expected that the protective coating will provide sufficient protection so the various ingredients contained in a wide variety of packaged goods, including but not limited to acids, salts, fats, high-staining materials, oils, spices, and flavorings, do not penetrate the coating and cause a degradation of the package rendering the contents of the package unfit for human consumption. Additionally, the protective coating should neither impart an unpalatable taste or odor to the contents of the package, nor leach into the contents of the package and mingle with the food, beverage, consumer goods or packaging-related materials. Ideally, the coating used to protect the packaging article can be applied and employed in processes substantially similar to those currently in use and can be used across a broad spectrum of packaging articles and food, beverage, consumer goods and packaging-related material types.

The present invention addresses the deficiencies of the prior art by providing materials to be used as coatings on metal and plastic containers for the storage of food, beverage, consumer goods and packaging-related materials. While patent literature exists on polybutadiene polymers being utilized in beverage containers (U.S. Pat. No. 3,879,331, Apr. 22, 1975, assigned to E.I. du Pont de Nemours and Co., and U.S. Pat. No. 3,268,620, Aug. 23, 1966, assigned to American National Can Co.), the present invention utilizes low molecular weight, low viscosity materials, thereby allowing higher non-volatile content of the coating when applied. The materials of the present invention thus represent an improvement over the prior art that employed high molecular weight (and inherently higher viscosity) materials resulting in low non-volatile content in the coating materials. Additionally, the present invention may be used in containers housing a broad range of foods, beverages, consumer goods and packaging-related materials which vary considerably with their demand to resistance to these products, in contrast to the prior art, which was limited to use with non-aggressive beverages and materials.

### SUMMARY OF THE INVENTION

The present invention provides novel and improved compositions and methods for coating the surfaces of beverage, food, consumer good and packaging-related material containers. The coatings preferably do not include bisphenol A, bisphenol F, and aromatic glycidal ethers. The coatings may be adhered to plastic and metal surfaces and, as such, can be used in a wide variety of containers. Such containers include, but are not limited to, plastic containers, beverage cans, canned food, large pails, five-gallon drums, kegs, canisters, fifty-gallon drums, and other large-volume containers.

It is an object of the present invention to provide a composition for coating the surface of a foodstuff or consumer good container. The composition may include a volatile component and non-volatile component. The non-volatile component may include a butadiene polymer, a phenolic resin, and a surface active agent.

The butadiene copolymer may include styrene butadiene copolymer, which may be present at a concentration of about 70 to about 90 parts by weight of the non-volatile component.

The surface active agent may be a surface active wetting agent and may be present at concentration of about one to about five parts by weight of the non-volatile component. The composition may include a second surface active agent, acting as a lubricant. The surface active lubricant may be present at a concentration of about 0.5 to about 5 parts by weight of the non-volatile component.

The composition may also include a metallic drier, an acid catalyst, or combinations thereof present at a concentration of less than about one part by weight of the non-volatile component.

The phenolic resin may be present in the composition at a concentration of about 5 to about 30 parts by weight of the non-volatile component.

The volatile component may be selected from the group consisting of ethylene glycol monobutyl ether, Stoddard solvents, aromatic solvents, n-butyl alcohol, mineral spirits, and ethylene glycol monobutyl ether.

It is another object of the present invention to provide compositions for coating the surface of a beverage container. Such compositions are similar to those used for food or consumer goods containers, but preferably lack phenolic resin.

Both compositions may include additives such as organo-silanes, benzoguanamine resin, solution vinyl resin, vinyl butyral, silica, talc, and mixtures thereof.

### BRIEF DESCRIPTION OF THE DRAWINGS

For the present invention to be clearly understood and readily practiced, the present invention will be described in conjunction with the following figures, wherein like reference characters designate the same or similar elements, which figures are incorporated into and constitute a part of the specification, wherein:

FIG. 1 shows a metallic can to be coated by the compositions of the present invention; and

FIG. 2 displays a cut-away view of the interior of the metallic can of FIG. 1 showing the composition coated on the interior surface of the can.

### DETAILED DESCRIPTION OF THE INVENTION

It is to be understood that the figures and descriptions of the present invention have been simplified to illustrate elements that are relevant for a clear understanding of the invention, while eliminating for purposes of clarity, other elements that may be well known. The detailed description will be provided hereinbelow with reference to the attached drawings.

The present invention provides a composition for coating foodstuff and consumer product containers that overcomes many of the shortcomings of the prior art. Importantly, the compositions of the present invention do not include bisphenol A or related compounds, thus obviating the health concerns regarding those products. Furthermore, the present invention provides for excellent adhesion of the coating(s) to metal substrates commonly used in the manufacture of packaging containers. The coatings of the present invention also provide superior protection between the contents of the package and the package itself by possessing excellent chemical resistance and providing an inert, continuous, and stain-resistant barrier over the substrate of the container. The coatings of the present invention also provide sufficient flexibility to withstand the fabrication and formation requirements involved while manufacturing packaging articles, particularly those that are manufactured from flat sheets or coils of metal to which the protective (and sometimes decorative) coatings are applied and cured before the packaging article is formed. The coatings of the present invention also provide the ability to form liquid coatings that contain little to no carrier solvent (effectively zero VOC) which is advantageous from environmental and occupational health perspectives. The coatings of the present invention may be used effectively with traditional food and beverage containers (e.g., canned food goods, cans of soda). Further, the present invention may also be used in any other context where food, beverages, consumer products, or other packaging-related materials that come in contact with foodstuffs and/or beverages are stored. For example, foodstuffs and/or beverages may be transported in large pails, five-gallon drums, kegs, canisters, fifty-gallon drums, or other large-volume containers. The present invention is equally appropriate for use in those contexts as in smaller canned goods.

To assess stability of a coating, numerous tests may be performed. The container to which the coating is applied may be challenged with industry-standard tests such as a bend tests, adhesion tests, abrasion tests, and impact tests to confirm physical stability. The coatings may also be challenged with intensive exposure to chemical compositions to confirm stability in the face of such chemical attacks as would be experienced in practice. Additionally, the long-term stability of the coatings under realistic storage conditions may be tested by using an accelerated storage test. In the accelerated storage test, a container is coated with the compositions of the present invention and the coatings are cured. The container is then filled with a chemical, foodstuff, beverage, consumer good or packaging-related material that is likely to be housed in the container. The container is sealed and heated (e.g., in an oven) for an extended period (e.g., thirty days). This test approximates three months of storage under ambient conditions. After the extended period, the container is removed from the heated environment, and both the coating and the contents of the container are evaluated for compliance with appropriate storage standards.

Additionally, some researchers have raised a concern regarding the transportation of materials used in chemical coatings for foodstuff containers. Even though those material may not contain bisphenol A or related compounds of concern, the coatings of the containers in which those chemicals are shipped may contain bisphenol A or related compounds. The bisphenol A or related compound present in the coatings of those containers may leach into the chemicals being transported, thus introducing potentially hazardous chemicals into the food storage process unexpectedly. To avoid this problem, the compositions of the present invention may be used to coat the interior surface of containers that are used to transport the chemicals used in coating.

The present invention relates to novel organic coating compositions particularly adapted for application to substrate (e.g., metal) surfaces routinely used in the manufacture of packaging articles. More specifically, the present invention encompasses a family of compositions containing commonly available liquid unsaturated polybutadiene polymers, and/or liquid copolymers of styrene butadiene, and/or liquid functionalized copolymers of styrene butadiene used in conjunction with other polymers of various chemistries. Those additional polymers include, but are not limited to, polyester resins, acrylic resins, vegetable oils, vinyl resins and phenolic resins.

The coatings of the present invention may also include other additives and modifying ingredients to impart desired application, adhesion, or performance properties. Examples of such materials include, but are not limited to, organo-silanes, benzoguanamine resin, solution vinyl resin, vinyl butyral, silica, talc, and mixtures thereof. One of skill in the art will recognize numerous additional materials that may be substituted freely for these recited components. These additives may be particularly useful in improving inter-coat adhesion.

The coatings of the present invention preferably include a volatile component and a non-volatile component. The volatile component may include numerous solvents or carriers known in the art, including, but not limited to, ethylene glycol monobutyl ether, Stoddard solvents, aromatic solvents, n-butyl alcohol, mineral spirits, and ethylene glycol monobutyl ether. One of skill in the art will recognize additional materials that may be substituted freely for these recited components. The composition of the non-volatile (solid) component coating may vary depending on the application environment in which the coating will be used. The non-volatile solid component may include butadiene polymers/copolymers and phenolic resin as major components, as specified below.

The non-volatile component may be included at a concentration of 40% to 100% of the coating mixture. The specific concentration in the coating composition will depend on the end use application. Further, there is also a relation between the percentage of the non-volatile component and the application method (i.e., spray vs. roll coat). As the relative proportion of the volatile component increases, the more liquid the composition becomes, permitting spray-based application methods to be used. One of skill in the art will recognize that the relative concentration of volatile to non-volatile components may be selected appropriately to facilitate the particular application at hand. For example, the composition may be more flexible or more brittle by adjusting the relative proportions of non-volatile components, as well as through the inclusion of additives as disclosed below.

For lining containers that house food and/or consumer goods, the composition may include a butadiene copolymer, phenolic resin, surface active wetting agent, surface active lubricant, and other ancillary components in the non-volatile, solid component. In this context, the concentration of styrene butadiene copolymers may range from about 70 to about 90 parts by weight of the non-volatile solids. In some embodiments, the styrene butadiene copolymers may be present at 90 parts by weight of the non-volatile solids. The styrene butadiene copolymers may be formed by utilizing a wide variety of butadiene-containing compounds, such as RICON 184, RICON 184MA6, and RICON 157. The specific components employed will depend on the end application and one of skill in the art will readily recognize the appropriate components to employ.

The concentration of the phenolic resin may range from about 5 to about 30 parts by weight of the non-volatile solids. In some embodiments, the phenolic resin is present at 15 parts by weight of the non-volatile solids. The concentration of surface active wetting agents may range from about 1 to about 5 parts by weight of the non-volatile solids. In some embodiments, the surface active wetting agent may be present at two parts by weight of the non-volatile solids. The concentration of surface active lubricant may range from about 0.5 to about 5 parts by weight of the non-volatile solids. In some embodiments, the surface active lubricant may be one part by weight of the non-volatile solids. The composition may also include less than about one part by weight of the non-volatile solids of a metallic drier or acid catalyst to impart additional chemical resistance to the cured film.

For lining containers that house beverages, the composition may include a butadiene copolymer, surface active wetting agents, and a metallic drier in the non-volatile, solid component. In those embodiments for beverage containers, it is generally appropriate to avoid the use of phenolic resin in the coating composition. As for food and consumer goods containers, the non-volatile component may be included at a concentration of 40% to 100% of the coating mixture. The specific concentration in the coating composition will depend on the end use application.

The concentration of liquid unsaturated polybutadiene polymer in these compositions may range from about 70 to about 99 by weight of the non-volatile solids. In some embodiments, the liquid unsaturated polybutadiene polymer may be present at and preferably 95 parts of the non-volatile solids. The formulation may be modified with a liquid copolymer of styrene butadiene at a range from about 0 to about 15 parts by weight of the non-volatile solids. In some embodiments, the liquid copolymer of styrene butadiene may be present at 5 parts of the non-volatile solids. Less than about one part by weight of the non-volatile solids of the composition may include surface active wetting agents and/or a metallic drier.

The present invention allows producers of packaging articles to utilize commonly used processes, procedures, substrates, and practices in the manufacture of their respective products. The coating materials of the present may possess numerous beneficial properties, including: 1) being low in viscosity for ease of application and the ability to achieve high non-volatile finished coatings; 2) being suitable for direct contact with foods, beverages, consumer goods, and packaging-related materials when properly applied and cured; 3) lacking components that include bisphenol A, bisphenol F, or aromatic glycidal ether compounds as building blocks; 4) can be applied onto and will adhere to metal substrates typically used in packaging articles; and 5) can be blended in ratios to make compositions having a wide variety of physical properties (e.g., hard and brittle, or soft and flexible coatings) so as to be useful in diverse product package applications.

The compositions described above may be applied to the interior and/or exterior surfaces of various containers. The composition may be applied to the surface of the container by methods well known in the art (e.g., roll coating or spray coating). The container with coating applied may then be cured for the appropriate duration and under the appropriate conditions, as is well known in the art. In a specific example, the compositions may be sprayed onto the surface of a metallic container and subsequently cured at an elevated temperature using conventional heating equipment well known in the art. Generally, the compositions may be cured from between about 10 seconds to about 30 minutes at temperatures ranging from about 350° F. to about 600° F. The coating of the compositions of the present invention may thus form a resilient and stable barrier to interaction between foods, beverages, and/or commercial goods inside of the container and the metallic surface of the container. In some embodiments, the coating is administered at a density between about 1 and about 200 milligrams per four square inches of surface area of the container surface.

The present invention will be demonstrated through the following non-limiting examples.

### Example 1

The composition disclosed in this example may be used for coating the surface of metal containers that may house food. The composition includes the following components.

| Material | Percent |
|---|---|
| RICON 184MA6 (maleinized butadiene styrene copolymer) | 34.97% |
| RICON 184 (butadiene styrene copolymer) | 8.71% |
| Odorless mineral spirits solvent | 23.49% |
| Ethylene glycol monobutyl ether | 23.49% |
| Phenodur PR516/60B (phenolic resin) | 7.77% |
| S-Nauba 5021 (carnauba wax blend) | 0.52% |
| Byk 359 (acrylic surface active agent) | 0.37% |
| Byk 392 (surface active agent) | 0.28% |
| Byk A501 (defoamer) | 0.36% |
| 6% manganese Hex-Chem (metallic drier) | 0.03% |
| | 100.00% |

The above components are mixed using conventional mixing machinery to form a liquid composition. That composition may then be roller-coated or sprayed onto a metallic container that is to house food. The roller-coated substrate or container would be heated to allow the coating to cure prior to packing with food.

### Example 2

The composition disclosed in this example may be used for coating the surface of metal containers that may house beverage. The composition includes the following components.

| Material | Percent |
|---|---|
| RICON 157 (polybutadiene) | 44.68% |
| Odorless mineral spirits solvent | 46.32% |
| Modaflow (acrylic flow additive) | 0.30% |
| Ethylene glycol monobutyl ether | 8.66% |
| 6% manganese Hex-Chem (metallic drier) | 0.04% |
| | 100.00% |

The above components are mixed using conventional mixing machinery to form a liquid composition. That composition may then be sprayed onto a metallic container that is to contain a beverage. The container would be heated to allow the coating to cure prior to packing with beverage.

Nothing in the above description is meant to limit the present invention to any specific materials, geometry, or specific combinations of chemical components. Many modifications are contemplated within the scope of the present invention and will be apparent to those skilled in the art. The embodiments described herein were presented by way of example only and should not be used to limit the scope of the invention.

What is claimed is:

1. A composition for coating of a surface of a foodstuff or consumer good container, comprising:
a volatile component; and
a non-volatile component, wherein said non-volatile component further comprises:
a butadiene polymer;
a phenolic resin; and
a surface active agent.

2. The composition of claim 1, wherein said butadiene copolymer is styrene butadiene copolymer.

3. The composition of claim 2, wherein said styrene butadiene copolymer is present at a concentration of about 70 to about 90 parts by weight of the non-volatile component.

4. The composition of claim 1, wherein said surface active agent is a surface active wetting agent.

5. The composition of claim 4, wherein said surface active wetting agent is present at a concentration of about 1 to about 5 parts by weight of the non-volatile component.

6. The composition of claim 1, further comprising a second surface active agent, wherein said second surface active agent is a surface active lubricant.

7. The composition of claim 6, wherein said surface active lubricant is present at a concentration of about 0.5 to about 5 parts by weight of the non-volatile component.

8. The composition of claim 1, further comprising a metallic drier, acid catalyst, or combination thereof.

9. The composition of claim 8, wherein said metallic drier, acid catalyst, or combination thereof is present at a concentration of less than about 1 parts by weight of the non-volatile component.

10. The composition of claim 1, wherein said phenolic resin is present at a concentration of about 5 to about 30 parts by weight of the non-volatile component.

11. The composition of claim 1, wherein said volatile component is selected from the group consisting of ethylene glycol monobutyl ether, Stoddard solvents, aromatic solvents, n-butyl alcohol, mineral spirits, and butyl cellosolve.

12. The composition of claim 1, further comprising an additive selected from the group consisting of organo-silanes, benzoguanamine resin, solution vinyl resin, vinyl butyral, silica, talc, and mixtures thereof.

13. The composition of claim 1, wherein the non-volatile component is present at a concentration of about 40% to about 100% of the composition.

14. A composition for coating of a surface of a beverage container, comprising:
a volatile component; and
a non-volatile component, wherein said non-volatile component further comprises:
a butadiene polymer; and
a surface active agent.

15. The composition of claim 14, wherein said butadiene polymer is a liquid unsaturated polybutadiene polymer.

16. The composition of claim 15, wherein said liquid unsaturated polybutadiene polymer is present from about 70 to about 99 parts by weight of the non-volatile solids.

17. The composition of claim 14, wherein composition further comprises a liquid copolymer of styrene butadiene.

18. The composition of claim 17, wherein said liquid copolymer of styrene butadiene is present about five parts by weight of the non-volatile component.

19. The composition of claim 14, further comprising a metallic drier.

20. The composition of claim 14, wherein said composition is substantially free of bisphenol A, bisphenol F, and aromatic glycidal ether.
